(19) United States
(12) Patent Application Publication
(10) Pub. No.: US 2007/0030295 A1
(43) Pub. Date: Feb. 8, 2007

(54) Methods and systems for signal display

(75) Inventor: Min-Jye Chen, Miaoli (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/473,849

(22) Filed: Jun. 23, 2006

(30) Foreign Application Priority Data
Aug. 8, 2005 (TW) TW94126677

(51) Int. Cl. G09G 5/02

(52) U.S. Cl. 345/698

(57) ABSTRACT

Methods and systems for signal display are provided. Resolution data of signals received by an electronic display device is sent to a computer and determined if it is stored in a first table, recording resolution data and corresponding display data, in the computer. If so, the corresponding display data is sent to the electronic display device for signal display. If not, the resolution data is determined if it is recorded in a second table, established outside the computer and recording the resolution data and corresponding display data. If so, the corresponding display data is sent to the electronic display device and recorded to the first table in the computer.

### BACKGROUND OF THE INVENTION

1. Field of the Invention

The present invention relates to a method for signal display, and in particular to a method for signal display applied in an electronic display device capable of displaying signals with unknown resolution.

2. Description of the Related Art

With the progress of signal processing technology, electronic display devices, such as liquid crystal display (LCD) devices, are widely employed in different fields. A single electronic display device may be required to conform to various specifications or different resolutions. For example, an LCD device for a desktop computer may display signals originally provided to an LCD of a notebook.

For an electronic display device, since the probability of receiving signals with unknown resolution is increased, the probability of displaying signals with unknown resolution is also increased. For example, an electronic display device conforms to a specification A (1280×1024), and a specification B (1280×768) is generated thereafter. For the electronic display device conforming to the specification A, signals of specification B have unknown resolution. When the electronic display device conforming to the specification A displays the signals of specification B, the images are not correctly presented on the electronic display device. If an electronic display device still displays the unknown resolution, shift or distortion may occur in the images, and the display function of the electronic display device is impaired.

To ameliorate described problem, current solutions employ simulated resolution to approximate the unknown resolution. According to this method, the degree of shift or distortion can be degraded, however, and the images are not displayed correctly. Moreover, in some situations, if the electronic display device can not obtain or calculate applicable simulated resolution, the images are seriously distorted, hence, the display device may present a black image, for example. Thus, users must reset the electronic display device or a main system, resulting in great inconvenience for usage and damage to the main system.

Thus, electronic display devices correctly capable of displaying signals with unknown resolution are desirable.

### BRIEF SUMMARY OF THE INVENTION

An exemplary embodiment of a method for signal display is provided. The method is applied in an electronic display device which displays signals input to the electronic display device. First, resolution data of the signals is sent to a computer coupled to the electronic display device. The resolution data can be sent to the computer via wires or wirelessly. The resolution data is obtained by detecting the signals by the electronic display device. The resolution data comprises horizontal synchronization (Hsync) and vertical synchronization (Vsync) of the signals.

Then, the resolution is determined if it is stored in a first table of the computer. The first table is used to record the resolution data and corresponding display data. When the resolution data is stored in the first table, the corresponding display data is sent to the electronic display device.

When the resolution data is not stored in the first table, it is determined if the resolution data is stored in a second table. The second table is established in a server outside the computer and records the resolution data and the corresponding display data. Before it is determined if the resolution data is stored in the second table, the resolution data is sent to the server. The resolution data is sent to the server via wires or wirelessly.

When the resolution data is stored in the second table, the corresponding display data is sent to the electronic display device and recording the corresponding display data into the first table of the computer. When the resolution data is not stored in the second table, the electronic display device displays the signals with predetermined resolution. The purpose of displaying the signals with the predetermined resolution to prevent a full black or distorted image. Moreover, the electronic display device comprises a display data table for storing the display data of the signals.

An exemplary embodiment of a storage medium is provided. The storage medium stores a computer program providing a method for signal display, comprising using a computer to perform the above steps.

An exemplary embodiment of a system for signal display is provided. The system is applied in an electronic display device which displays signals input to the electronic display device and comprises a resolution data sending module, a first determination module, a first display data sending module, a second determination module, and a second display data sending module.

The resolution data sending module sends resolution data of the signals to a computer coupled to the electronic display device via wires or wirelessly. The resolution data is obtain by detecting the signals by the electronic display device and comprises horizontal synchronization (Hsync) and vertical synchronization (Vsync) of the signals.

The first determination module determines if the resolution data is stored in a first table of the computer. The first table is used to record the resolution data and corresponding display data.

The first display data sending module sends the corresponding display data to the electronic display device when the resolution data is stored in the first table. The electronic display device thus displays the signals according to the corresponding display data.

The second determination module determines if the resolution data is stored in a second table when the resolution data is not stored in the first table. The second table which is established outside the computer and records the resolution data and the corresponding display data. For example, the second table is established in a server. Before the second determination module determines if the resolution data is stored in the second table, a sending module sends the predetermined resolution data to the server via wires or wirelessly.

The second display data sending module sends the corresponding display data to the electronic display device and records the corresponding display data into the first table of the computer when the resolution data is stored in the second table. When the resolution data is not stored in the second table, the electronic display device displays the signals at a predetermined resolution. Moreover, the electronic display device comprises a display data table for storing the display data of the signals.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is flowchart of an embodiment of a method for signal display;

FIG. 2 is a diagram of an embodiment of a storage medium; and

FIG. 3 is a function block diagram of an embodiment of a system for signal display.

### DETAILED DESCRIPTION OF THE INVENTION

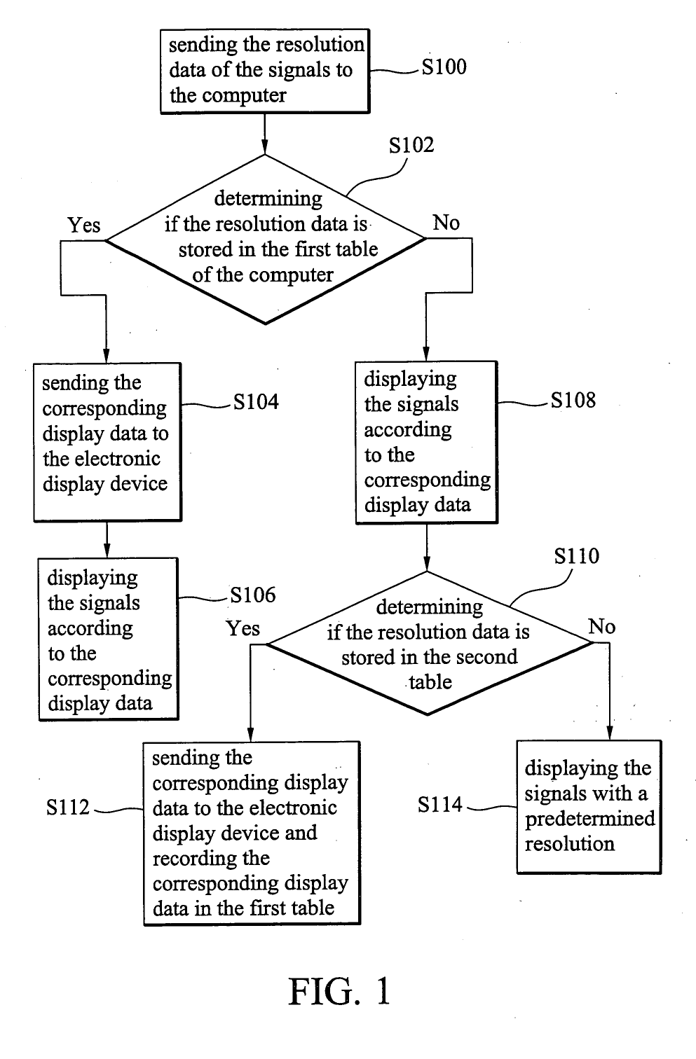

Methods for signal display are provided. FIG. 1 is flowchart of a method for signal display. The embodiment of the method is applied in an electronic display device displaying signals which are input to the electronic display.

First, resolution data of signals is sent to a computer of the electronic display device via wires or wirelessly (step S100). The resolution data is obtained by detecting the signals by the electronic display device and comprises horizontal synchronization (Hsync) and vertical synchronization (Vsync).

The resolution data is then determined if it is stored in a first table of the computer (step S102). The first table is used to record the resolution data and corresponding display data. When the resolution data is stored in the first table, the computer sends the corresponding display data to the electronic display device (step S104). The electronic display device then displays the signals according to the display data sent by the computer (step S106).

The embodiment of the method further provides a second table which is established outside the computer and records the resolution data and the corresponding display data. The second table is established in a server, such as a server provided by the producer of the electronic display device. When the resolution data is not stored in the first table, the resolution data is sent to the server (step S108) via wires or wirelessly, such as via a wired or wireless network.

It is determined if the resolution data is stored in the second table (step S110). When the resolution data is stored in the second table, the corresponding display data is sent to the electronic display device and recorded in the first table of the computer (step S112).

When the resolution data is not stored in the second table, the electronic display device displays the signals with predetermined resolution (step S114). The electronic display device can comprise a data table for storing the display data of the signals.

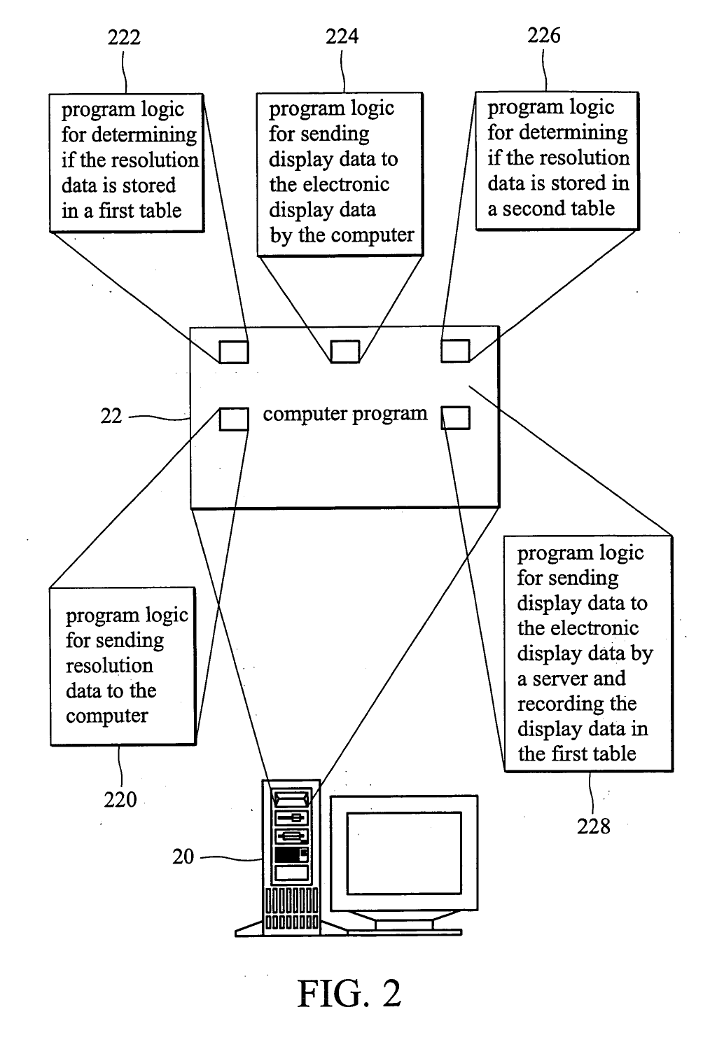

FIG. 2 is a diagram of an embodiment of a storage medium for storing a computer program providing a method for signal display. Referring to FIG. 2, a storage medium 20 storing a computer program 22 is provided. The computer program 22 is loaded to a computer, and the computer performs the described method for signal display. The computer program 22 comprises a program logic 220 for sending resolution data to the computer, a program logic 222 for determining if the resolution data is stored in a first table, a program logic 224 for sending display data to the electronic display data by the computer, a program logic 226 for determining if the resolution data is stored in a second table, and a program logic 228 for sending display data to the electronic display data by a server and recording the display data in the first table.

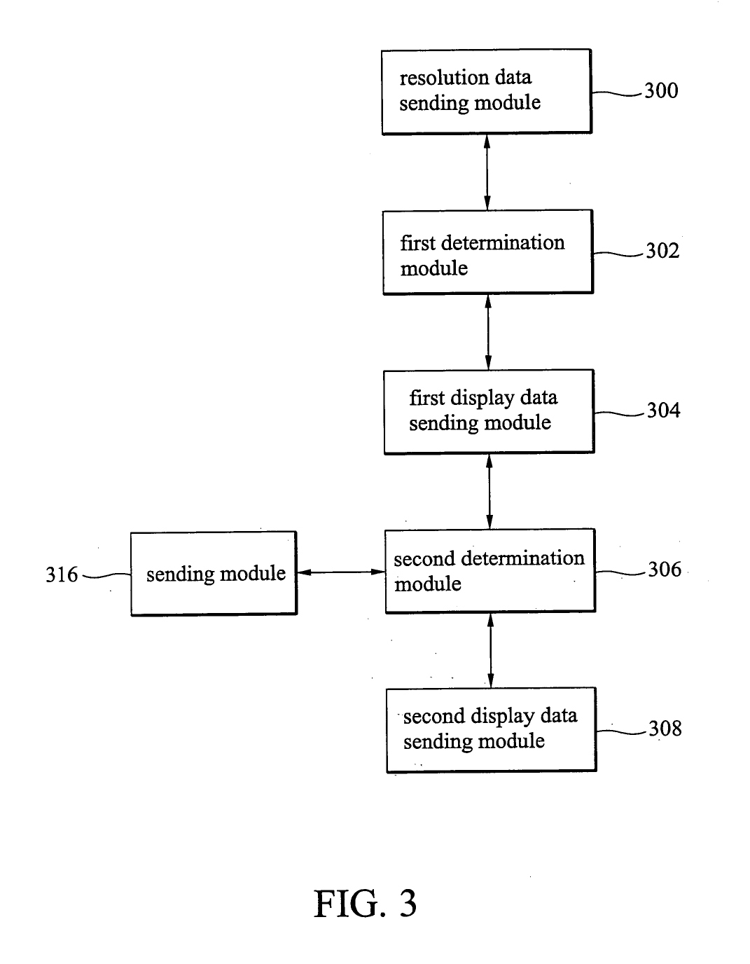

FIG. 3 is a function block diagram of an embodiment of a system for signal display. The system is applied in an electronic display device displaying signals provided to the electronic display device. The system comprises a resolution data sending module 300, a first determination module 302, a first display data sending module 304, a second determination module 306, and a second display data sending module 308.

The resolution data sending module 300 sends resolution data of the signals to a computer coupled to the electronic display device. The resolution data is obtained by detecting the signals by the electronic display device and comprises horizontal synchronization (Hsync) and vertical synchronization (Vsync).

The first determination module 302 determines if the resolution is stored in a first table of the computer. The first table is used to record the resolution data and corresponding display data. The resolution data of signals is sent to the computer via wires or wirelessly

When the resolution data is stored in the first table, the first display data sending module 304 sends the corresponding display data to the electronic display device. The electronic display device then displays the signals according to the display data sent by the computer.

When the resolution data is not stored in the first table, the second determination module 306 determines if the resolution data is stored in the second table. The second table is established outside the computer and records the resolution data and the corresponding display data. The second table is established in a server. Before the second determination module 306 determines if the resolution data is stored in the second table, the predetermined resolution data is sent to the server by a sending module 316. The sending module 316 sends the resolution data via wires or wirelessly.

When the resolution data is stored in the second table, the second display data sending module 308 sends the corresponding display data to the electronic display device, and the resolution data is recorded in the first table of the computer. When the resolution data is not stored in the second table, the electronic display device displays the signals with predetermined resolution. The electronic display device comprises a display data table for storing the display data of the signals.

Thus, according to a method and system for displaying and extending signals with unknown resolution, when receiving the signals with unknown resolution, an electronic display device can extend display data and display signals with the unknown resolution. The method and system for signal display may potentially resolve the potential inconvenience of conventional manual mode determination.

A method and system of the present invention, or certain aspects or portions of embodiments thereof, may take the form of program code (i.e., instructions) embodied in media, such as floppy diskettes, CD-ROMS, hard drives, firmware, or any other storage medium, wherein. When the program code is loaded into and executed by a machine, such as a computer, the machine becomes an apparatus for practicing and embodiment of the invention. The method and system of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for signal display applied in an electronic display device displaying signals input to the electronic display device, comprising:
sending resolution data of the signals to a computer coupled to the electronic display device, wherein the electronic display device obtains the resolution data by detecting the signals by;
determining if the resolution data is stored in a first table of the computer, wherein the first table is used to record the resolution data and corresponding display data;
sending the corresponding display data to the electronic display device when the resolution data is stored in the first table;
determining if the resolution data is stored in a second table when the resolution data is not stored in the first table, wherein the second table is established outside the computer and records the resolution data and the corresponding display data; and
sending the corresponding display data to the electronic display device and recording the corresponding display data in the first table of the computer when the resolution data is stored in the second table.

2. The method for signal display as claimed in claim 1 further comprising displaying the signals with predetermined resolution by the electronic display device when the resolution data is not stored in the second table.

3. The method for signal display as claimed in claim 1, wherein when the resolution data is stored in the first table, the electronic display device then displays the signals according to the corresponding display data sent by the computer.

4. The method for signal display as claimed in claim 1, wherein the resolution data comprises horizontal synchronization (Hsync) and vertical synchronization (Vsync) of the signals.

5. The method for signal display as claimed in claim 1, wherein the second table is established in a server.

6. The method for signal display as claimed in claim 5 further comprising sending the resolution data to the server before the step of determining if the resolution data is stored in the second table.

7. The method for signal display as claimed in claim 6, wherein the resolution data is sent to the server by wires or wirelessly.

8. The method for signal display as claimed in claim 1, wherein the resolution data is sent to the computer via wires or wirelessly.

9. The method for signal display as claimed in claim 1, wherein the electronic display device comprises a display data table for storing the display data of the signals.

10. A storage medium for storing a computer program providing a method for signal display, comprising using a computer to perform the steps claimed in claim 1.

11. A system for signal display applied in an electronic display device displaying signals input to the electronic display device, comprising:
a resolution data sending module sending resolution data of the signals to a computer coupled to the electronic display device, wherein the resolution data is obtained by detecting the signals by the electronic display device;
a first determination module coupled to the resolution data sending module and determining if the resolution data is stored in a first table of the computer, wherein the first table is used to record the resolution data and corresponding display data;
a first display data sending module coupled to the first determination module and sending the corresponding display data to the electronic display device when the resolution data is stored in the first table;
a second determination module coupled to the first display data sending module and determining if the resolution data is stored in a second table when the resolution data is not stored in the first table, wherein the second table which is established outside the computer and records the resolution data and the corresponding display data; and
a second display data sending module coupled to the second determination module and sending the corresponding display data to the electronic display device and recording the corresponding display data in the first table of the computer when the resolution data is stored in the second table.

12. The system for signal display as claimed in claim 11, wherein the electronic display device displays the signals with predetermined resolution when the resolution data is not stored in the second table.

13. The system for signal display as claimed in claim 11, wherein when the resolution data is stored in the first table, the electronic display device then displays the signals according to the corresponding display data sent by the computer.

14. The system for signal display as claimed in claim 11, wherein the resolution data comprises horizontal synchronization (Hsync) and vertical synchronization (Vsync) of the signals.

15. The system for signal display as claimed in claim 11, wherein the second table is established in a server.

16. The system for signal display as claimed in claim 15 further comprising a sending module for sending the resolution data to the server before the second determination module determines if the resolution data is stored in the second table.

17. The system for signal display as claimed in claim 16, wherein the sending module sends the resolution data to the server via wires or wirelessly.

18. The system for signal display as claimed in claim 11, wherein the resolution data is sent to the computer via wires or wirelessly.

19. The system for signal display as claimed in claim 11, wherein the electronic display device comprises a display data table for storing the display data of the signals.
